(19) United States
(12) Patent Application Publication
(10) Pub. No.: US 2010/0105547 A1
(43) Pub. Date: Apr. 29, 2010

(54) OXIDATION CATALYST COMPOSITION AND PM OXIDATION CATALYST

(75) Inventors: Junji Ito, Kanagawa (JP); Yasunari Hanaki, Kanagawa (JP); Kouji Masuda, Tokyo (JP)

Correspondence Address: FOLEY AND LARDNER LLP;SUITE 500, 3000 K STREET NW, WASHINGTON, DC, 20007, US

(73) Assignee: NISSAN MOTOR CO., LTD., Kanagawa (JP)

(21) Appl. No.: 12/531,211

(22) PCT Filed: Apr. 17, 2008
(86) PCT No.: PCT/JP2008/057535

§ 371 Date: Sep. 14, 2009

(30) Foreign Application Priority Data
Apr. 18, 2007 (JP) 2007-108872

(51) Int. Cl. B01J 23/10; B01J 23/08; B01J 23/34

(52) U.S. Cl. 502/304

(57) ABSTRACT

[Object] To provide an oxidation catalyst composition excellent in low temperature activity and a PM oxidation catalyst which can oxidize or burn particulate and the like from an internal combustion engine even at relatively low temperatures.
[Solving Means] An oxidation catalyst composition contains cerium, manganese, and a metal M (M is a trivalent metal element excluding cerium). When the oxidation catalyst composition is analyzed by XPS so that orbital energies are subjected to peak separation using the Gaussian function, the Ce⁴⁺/Ce³⁺ atomic weight ratio (atomic % ratio) is 1.7 or higher and Mn²⁺ is in an amount of 5 atomic % or larger, wherein at least a part of the oxidation catalyst composition forms a composite.

The above-mentioned metal M is ytterbium, thulium, erbium, holmium, dysprosium, gadolinium, europium, samarium, promethium, neodymium, praseodymium, scandium, yttrium, aluminum, gallium and/or the like.

### TECHNICAL FIELD

This invention relates to an oxidation catalyst composition and a PM oxidation catalyst, more particularly to an oxidation catalyst composition excellent in low temperature activity and a catalyst using this, or a PM oxidation catalyst by which particulate and the like from an internal combustion engine and the like can be oxidized or burnt even at relatively low temperatures.

### BACKGROUND ART

Hitherto, the following method of regenerating a particulate filter is known in a diesel engine: Trapped particulate matter (PM) is subjected to oxidation or burning by raising the temperature of it under supply of electric power and the like or under consumption of fuel. However, regeneration under supply of electric power and the like unavoidably increases the amount of energy to be supplied; and regeneration by fuel unavoidably lowers a fuel economy.

In view of the above background, a catalyst is used to burn PM at low temperatures in order to lower an electric power consumption and to improve a fuel economy, in which improvements are being made on material and components of the catalyst.

For example, Ceₓ—Zr_{y}—Prₓ (x=0 to 0.3 mol %) is proposed to be used as a three-way catalyst (see, for example, Patent Citation 1).

Additionally, it is proposed to use Ce—Zr—M (M═La, Sm, Nd, Gd, Sc or Y) (see, for example, Patent Citation 2).
Patent Citation 1: Japanese Patent No. 3657620
Patent Citation 2: Japanese Patent No. 3528839

### DISCLOSURE OF THE INVENTION

### Problems to be Solved by the Invention

However, such conventional methods leave room for improvement in points of exhibiting an oxidation activity even at low temperatures and lowering PM oxidation temperatures.

This invention has been made in view of such problems which the conventional techniques have, and has an object to provide an oxidation catalyst composition excellent in low temperature activity and a PM oxidation catalyst which can oxidize or burn particulate and the like from an internal combustion engine even at relatively low temperatures.

### Means for Solving the Problems

The present inventors have conducted eager studies in order to attain the above object. As a result, it has been found to attain the above object by suitably using a certain metal together with cerium and manganese.

That is, an oxidation catalyst composition according to the present invention is characterized by containing cerium and manganese, and a metal M (M is a trivalent metal element excluding cerium),

wherein when the oxidation catalyst composition is analyzed by XPS (X-ray Photoelectron Spectroscopy) so that orbital energies are subjected to peak separation using the Gaussian function, the Ce⁴⁺/Ce³⁺ atomic weight ratio (atomic % ratio) is 1.7 or higher and Mn²⁺ is in an amount of 5 atomic % or larger,

wherein at least a part of the oxidation catalyst composition forms a composite.

Additionally, a PM oxidation catalyst according to the present invention is characterized by including the oxidation catalyst composition as mentioned above so as to oxidize hydrocarbons, carbon monoxide and particulate matter emitted from an internal combustion engine.

### EFFECTS OF THE INVENTION

According to the present invention, a certain metal is suitably used together with cerium and manganese, thereby providing an oxidation catalyst composition excellent in low temperature activity and a PM oxidation catalyst which can oxidize or burn particulate and the like from an internal combustion engine even at relatively low temperatures.

### THE BEST MODE FOR CARRYING OUT THE INVENTION

Hereinafter, the oxidation catalyst composition according to the present invention will be discussed further in detail. In the specification, [%] for concentration, content, blended amount and the like are represented by “mass percent” unless otherwise specified.

As discussed above, the oxidation catalyst composition according to the present invention contains cerium and manganese, and a metal M (M is a trivalent metal element excluding cerium), wherein at least a part of the oxidation catalyst composition forms a composite or compound. Additionally, when the oxidation catalyst composition is analyzed by XPS (X-ray Photoelectron Spectroscopy) so that orbital energies are subjected to peak separation using the Gaussian function, the Ce⁴⁺/Ce³⁺ atomic weight ratio (atomic % ratio) is 1.7 or higher and Mn²⁺ is in an amount of 5 atomic % or larger.

Here, the metal M may be metal elements except for cerium, and therefore concrete examples of the metal M are ytterbium (Yb), thulium (Tm), erbium (Er), holmium (Ho), dysprosium (Dy), gadolinium (Gd), europium (Eu), samarium (Sm), promethium (Pm), neodymium (Nd), praseodymium (Pr), scandium (Sc), yttrium (Y), aluminum (Al), gallium (Ga), and any combinations thereof.

Additionally, the oxidation catalyst composition according to the present invention has typically a structure of Ce⁴⁺—O—Mn²⁺—O-M, in which it is preferable that a part of the oxidation catalyst composition forms a composite, and it is more preferable that Ce⁴⁺ and Mn²⁺ form a composite which takes the form of a compound.

Under the effect of such formation of the composite, the oxidation activity at low temperatures can be improved, and additionally burning of particulate matter (hereafter referred to as “PM”) can be promoted.

Further, when the oxidation catalyst composition is analyzed by XPS so that orbital energies are subjected to peak separation using the Gaussian function, the Ce⁴⁺/Ce³⁺ atomic weight ratio (atomic % ratio) is 1.7 or higher and Mn²⁺ is in an amount of 5 atomic % or larger.

As an abundance ratio of the Ce⁴⁺ and Mn²⁺ is larger, the formation of composite of Mn and Ce is more promoted. When the Ce⁴⁺/Ce³⁺ atomic weight ratio (atomic % ratio) is 1.7 or higher and Mn²⁺ is in an amount of 5 atomic % or larger, the formation of the composite can be accomplished at at least a part of the oxidation catalyst composition, so that an oxidation velocity is also improved.

Furthermore, for the oxidation catalyst composition according to the present invention, it is preferable that cerium, Mn and the metal M coexist in either one of an observation range of particle observation by a transmission electron microscope (TEM) and an observation range corresponding to a column-like area having a diameter of 5 nm and a height of 100 nm in a X-ray analysis.

The coexistence of three substances, Ce, Mn and the metal M provides an advantage of improving the burning velocity of PM.

Next, a PM oxidation catalyst according to the present invention will be discussed.

As discussed above, this PM oxidation catalyst including the above-mentioned oxidation catalyst composition and has an oxidation activity at low temperatures owing to this oxidation catalyst composition. This PM oxidation catalyst can promote the PM oxidation for an internal combustion engine even at low temperatures, and therefore makes it possible to burn PM even at temperatures around 350° C.

Additionally, this PM oxidation catalyst promotes oxidation of hydrocarbons (HC) and carbon monoxide (CO) emitted from an internal combustion engine and therefore has a function to remove hydrocarbons and carbon monoxide.

In order to dispose the PM oxidation catalyst in an exhaust gas passage of an internal combustion engine, it is possible to cause the oxidation catalyst composition to be carried on a honeycomb-shaped monolithic carrier such as one formed of ceramic or of metal by using conventional and known inorganic base material such as alumina. This can also promote burning of PM and oxidation removal of HC and CO.

### Examples

Hereinafter, the present invention will be discussed with reference to Examples and Comparative Examples; however, the present invention is not limited to these Examples.

### Example 1

### Preparation of 77% CeO₂-8% Ga₂O₃-15% MnO₂ powder

Cerium acetate Ce(CH₃CO₂)₃, manganese acetate Mn(CH₃COO)₂ and gallium nitrate were mixed to prepare a solution. Ammonium was added dropwise in the solution to form precipitate of hydroxide, followed by aging over a whole day and night. Then, the precipitate was filtered and washed with water, and dried at 150° C. Thereafter, the precipitate was fired at 600° C. in the atmospheric air, thereby obtaining a composite oxide.

The thus obtained composite oxide had a composition of 77% CeO₂-8% Ga₂O₃-15% MnO₂ as the weight of oxides.

Subsequently, the obtained composite oxide was finely pulverized to a level of about 1 μm diameter by a ball mill thereby obtaining a PM oxidation material of this Example.

[Confirmation of Electronic State]

This PM oxidation material underwent an analysis of electronic state for Ce and Mn by XPS thereby making a peak separation thereby separating Ce⁴⁺, Ce³⁺, Mn³⁺ and Mn²⁺. The respective ion kinds and the composition of the complex oxide are shown in Table 1.

Here, the measuring condition of XPS was mentioned below.

Apparatus name: Composite-type surface analysis instrument (ESCA-5800) produced by Ulvac-phi, Incorporated

X-ray source: Mg—Kα ray (1253.6 eV) 300W

Photoelectron taking-out angle: 45 degrees (measuring depth: about 4 nm)

Measuring area: 2 mm×0.8 mm

Pre-treatment: After pulverization was made in an agate mortar, the PM oxidation material was subjected to a powder-compression forming onto an In foil, followed by undergoing a measurement.

[PM Burning Test]

The above-mentioned composite oxide and PM at a weight ratio of 1:1 were mixed for 20 minutes in an agate mortar. Then, 0.02 g of an obtained mixture was weighed and set in a glass reaction tube of the Quadrupole Mass Spectrometer (Q-MASS apparatus) of a gas analyzer. He gas was flowed at 100 cc/min. through the glass reaction tube, upon which a temperature was raised to a certain level which was maintained for 10 min. After stabilized, a balance gas of O₂10 vol. % He was added at 100 cc/min., upon which an ionic strength (M/Z=44 (mass number)) of CO₂ was monitored thereby measuring a burning behavior.

The condition of the above-mentioned mass spectrometric analysis was mentioned below.

Apparatus name: Gas analyzer (M-100GA-DM) produced by Canon Anelva Corporation

Measuring condition: Emission: 2.0 mA
SEM: 800 V
Sensitivity: 6.15E-8

Measurement M/Z: 2, 18, 28, 32 and 44

[PM Burning Velocity]

Immediately after the balance gas of O₂10 vol. % He was introduced in the PM burning test, the ionic strength of CO₂ increased thereby confirming PM burning. As PM decreased, the production amount of CO₂ decreased. This is assumed to result from the fact that contact of the catalyst and PM gradually reduces.

Accordingly, the real burning velocity of PM was measured by using an initial velocity method used in reaction engineering, in which the linearity of CO₂ production concentration relative to time was good for several seconds immediately after the introduction of the O₂10 vol. % He balance gas so that the PM burning velocity was determined according to an equation mentioned below. Obtained results are shown in Table 2.

PM burning velocity=ΔCO₂ production quantity/Δtime

### Example 2

### Preparation of 77% CeO₂-8% Y₂O₃-15% MnO₂ powder

Cerium acetate Ce(CH₃CO₂)₃, manganese acetate Mn(CH₃COO)₂ and yttrium acetate were mixed to prepare a solution. Ammonium was added dropwise in the solution to form precipitate of hydroxide, followed by aging over a whole day and night. Then, the precipitate was filtered and washed with water, and dried at 150° C. Thereafter, the precipitate was fired at 600° C. in the atmospheric air, thereby obtaining a composite oxide.

The thus obtained composite oxide had a composition of 77% CeO₂-8% Y₂O₃-15% MnO₂ as the weight of oxides.

Subsequently, the obtained composite oxide was finely pulverized to a level of about 1 μm diameter by a ball mill thereby obtaining a PM oxidation material of this Example.

Similarly to Example 1, the peak separation attributing to Ce and Mn was conducted by the photoelectron spectroscopy. Results are shown together with the oxide composition in Table 1.

Additionally, similarly to Example 1, the PM burning test was conducted thereby determining the PM burning velocity. Obtained results are shown in Table. 2.

[TEM Observation]

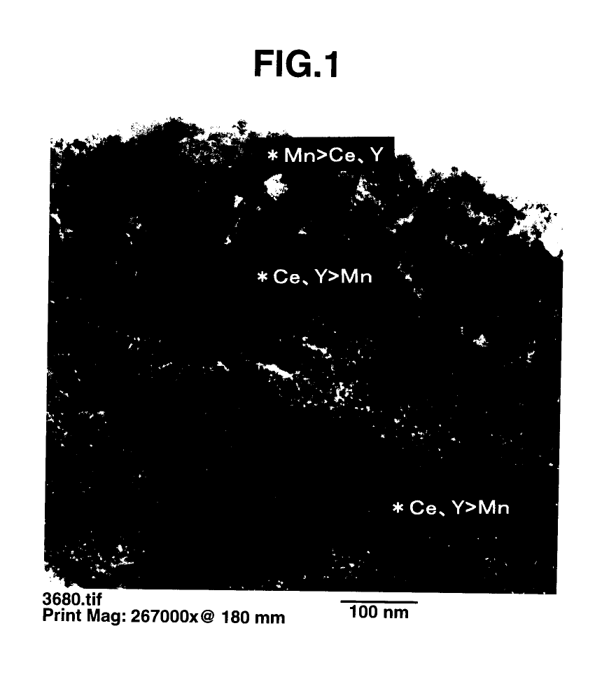

The composite oxide of this Example was observed under TEM (Transmission Electron Microscopy). Results of this observation are shown in FIG. 1. In FIG. 1, * indicates a site for a qualitative analysis, and an inequality sign indicates a small-large relationship in quantity in a measurement site.

The condition of TEM observation is mentioned below.

Apparatus name: Field emission transmission electron microscope (HF-2000) produced by Hitachi, Ltd.

Accelerating voltage: 200 kV

Pre-treatment: A segment by an ultrathin section method was about 100 nm, and a region for quantitative analysis is 5 nm in diameter. Therefore, a measurement place was in the shape of column having a diameter of 5 nm and a depth of 100 nm.

In order to demonstrate that the composite oxide state of Mn is preferable, a Ce—Y composite oxide which previously forms a compound state was impregnated with manganese acetate Mn(CH₃COO)₂ (Mn is Mn²⁺), and dried and fired in the same conditions as in the above⁻mentioned. This is a so-called impregnation method.

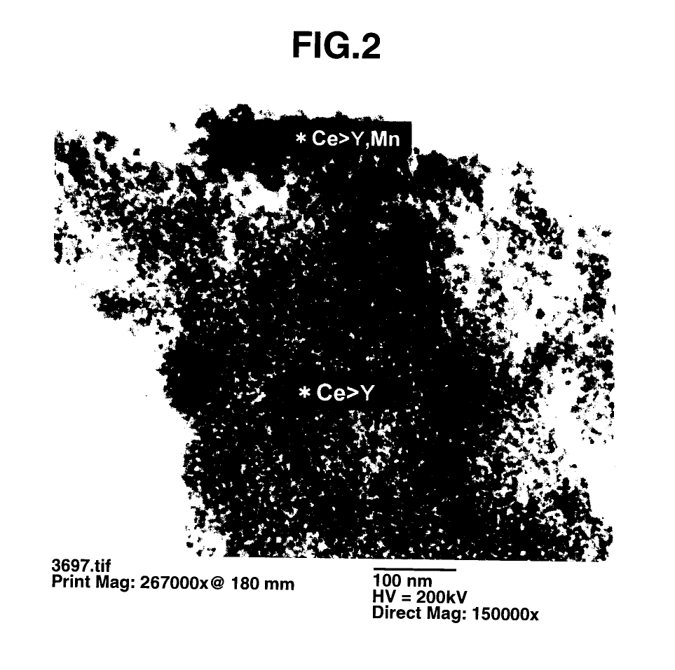

In FIG. 1, Ce, Y and Mn were observed in any observation sites. In FIG. 2, Mn was observed at the surface of particle whereas Mn was not observed inside particle. This means that Mn tends to aggregate but does not form a composite.

### Comparative Example 1

### Preparation of 77% CeO₂-15% ZrO₂-8% MnO₂ powder

Cerium acetate Ce(CH₃CO₂)₃, manganese acetate Mn(CH₃COO)₂ and zirconium oxynitrate ZrO(NO₃)₂.2H₂O were mixed to prepare a solution. Ammonium was added dropwise in the solution to form precipitate of hydroxide, followed by aging over a whole day and night. Then, the precipitate was filtered and washed with water, and dried at 150° C. Thereafter, the precipitate was fired at 600° C. in the atmospheric air, thereby obtaining a composite oxide.

The thus obtained composite oxide had a composition of 77% CeO₂-15% ZrO₂-8% MnO₂ as the weight of oxides.

Subsequently, the composite oxide was finely pulverized to a level of about 1 μm diameter by a ball mill thereby obtaining a PM oxidation material of this Example.

Similarly to Example 1, the peak separation attributing to Ce and Mn was conducted under the photoelectron spectroscopy. Obtained results are shown together with the oxide composition in Table 1.

Similarly to Example 1, the PM burning test was conducted thereby determining the PM burning velocity. Results are shown in FIG. 2.

TABLE 1

| | | Attribution to Mn | Attribution to Ce | | |
|---|---|---|---|---|---|
| | | Mn²⁺ quantity | Ce⁴⁺ quantity | Ce³⁺ | |
| | Composition | Atomic % | Atomic % | Atomic % | Ce⁴⁺/Ce³⁺ ratio |
| Example 1 | 77wt%CeO₂—8wt%Ga₂O₃—15wt%MnO₂ | 7.7 | 13.4 | 7.5 | 1.79 |
| Example 2 | 77wt%CeO₂—8wt%Y₂O₃—15wt%MnO₂ | 5.6 | 11.5 | 4.5 | 2.56 |
| Comparative | 77wt%CeO₂—15wt%ZrO₂—8wt%MnO₂ | 3.1 | 9.1 | 5.6 | 1.63 |
| Example 1 | | | | | |

TABLE 2

| | | PM burning velocity per 1 g |
|---|---|---|
| | | of the catalyst at 375° C. |
| | Composition | mg/SEC-g · cat |
| Example 1 | 77wt%CeO₂—8wt%Ga₂O₃—15wt%MnO₂ | 0.089 |
| Example 2 | 77wt%CeO₂—8wt%Y₂O₃—15wt%MnO₂ | 0.053 |
| Comparative | 77wt%CeO₂—15wt%ZrO₂—8wt%MnO₂ | 0.022 |
| Example 1 | | |

### BRIEF DESCRIPTION OF THE DRAWINGS

[FIG. 1] is a TEM observation photograph of a composite oxide of Example 2.

[FIG. 2] is a TEM observation photograph in case that a Ce—Y composite oxide was impregnated with Mn to carry Mn.

1-4. (canceled)

5. A method of producing an oxidation catalyst composition comprising:
mixing cerium, manganese, and a metal M (M is a trivalent metal element excluding cerium) to prepare a solution;
adding ammonia into the solution to form precipitate; and
aging, filtering, washing with water, drying and firing the precipitate to form an oxide composition containing cerium, manganese, and the metal M, wherein when the oxide composition is analyzed by XPS so that orbital energies are subjected to peak separation using Gaussian function, a Ce⁴⁺/Ce³⁺ atomic weight ratio (atomic % ratio) is 1.7 or higher and Mn²⁺ is in an amount of 5 atom % or larger, wherein at least a part of the oxide composition forms a composite.

6. A method as claimed in claim 5, wherein the metal M is at least one selected from the group consisting of ytterbium, thulium, erbium, holmium, dysprosium, gadolinium, europium, samarium, promethium, neodymium, praseodymium, scandium, yttrium, aluminum, and gallium.

7. A method as claimed in claim 5, wherein cerium, Mn and the metal M coexist in either one of an observation range of particle observation by a transmission electron microscope and an observation range corresponding to a column-like area having a diameter of 5 nm and a height of 100 nm in a X-ray analysis.

8. A method of producing a PM oxidation catalyst including the oxidation catalyst composition as claimed in claim 5 to oxidize hydrocarbons, carbon monoxide and particulate matter emitted from an internal combustion engine.

9. A method as claimed in claim 6, wherein cerium, Mn and the metal M coexist in either one of an observation range of particle observation by a transmission electron microscope and an observation range corresponding to a column-like area having a diameter of 5 nm and a height of 100 nm in a X-ray analysis.

10. A method of producing a PM oxidation catalyst including the oxidation catalyst composition as claimed in claim 6 to oxidize hydrocarbons, carbon monoxide and particulate matter emitted from an internal combustion engine.

11. A method of producing a PM oxidation catalyst including the oxidation catalyst composition as claimed in claim 7 to oxidize hydrocarbons, carbon monoxide and particulate matter emitted from an internal combustion engine.
